(19) United States
(12) Patent Application Publication
(10) Pub. No.: US 2009/0291224 A1
(43) Pub. Date: Nov. 26, 2009

(54) Porous Ceramic Thin Film

(75) Inventors: Daniel Beckel, Zurich (CH); Ludwig J. Gauckler, Zurich (CH)

Correspondence Address: BIRCH STEWART KOLASCH & BIRCH, PO BOX 747, FALLS CHURCH, VA, 22040-0747, US

(73) Assignee: Eidgenossische Technische Hochschule Zurich, Zurich (CH)

(21) Appl. No.: 12/085,218

(22) PCT Filed: Oct. 30, 2006
(86) PCT No.: PCT/CH2006/000605

§ 371 Date: Aug. 21, 2008

(30) Foreign Application Priority Data
Nov. 21, 2005 (CH) 185/05

(51) Int. Cl. B05D 1/32; B05D 3/02; B05D 5/12

(52) U.S. Cl. 427/466; 427/226; 427/227; 427/115; 427/77

(57) ABSTRACT

A sheet-like substrate (34) is coated with at least one thin film (36′) composed of at least one porous ceramic layer (S′₁, S′₂, S′₃, . . . ). A solution or a suspension of an organic and/or inorganic metal composite as starting material (14) is admixed with a mixed-in, insoluble pore former (18) and the mixture (22) is sprayed on as layer (S′₁, S′₂, S′₃, . . . ) of a thin film (36). The pore former (18) is at least partly thermally decomposed and/or burnt out to form an at least partly open-pored structure. The process is particularly suitable for producing miniaturized devices such as fuel cells and gas sensors.

### TECHNICAL FIELD

The invention relates to a process for coating a sheet-like substrate with at least one thin film comprising at least one porous ceramic layer and to uses of the process.

### PRIOR ART

Thin films, especially electrically conductive thin films, composed of ceramic materials are continuing to gain importance. The thin films generally comprise a plurality of layers, in particular from three to five layers, with the material and/or the morphology of the individual layers usually being different. The thin film is in practice deposited in layers on a substrate using customary thin film techniques. Deposition is achieved, for example, by chemical deposition from the gas phase, pulsed laser vapor deposition, sol-gel processes, in particular spin coating, or spray pyrrolysis. After or during application, the layers or the entire thin film are heat treated in a single-stage or multistage process in order to obtain a partly or fully crystalline microstructure.

U.S. Pat. No. 6,284,314 B1 discloses a porous ceramic film having micropores of uniform diameter. The layer is deposited from a ceramic sol using polyethylene glycol or polyethylene oxide and the substrate is then heated. This porous ceramic film is employed as catalyst or as catalyst support. A ceramic film comprising titanium oxide is particularly valuable as photocatalyst for the decomposition of harmful or foul-smelling substances.

US 2004/0166340 A1 describes a process for the deposition of thin film coatings of porous ceramic which comprise metal particles and composite materials produced by the process employed. This process comprises application of solutions comprising inorganic starting materials of porous ceramic and organic starting materials comprising at least one metal-containing component to a substrate, drying and decomposition of the starting materials to form a composite material. The composite materials obtained can vary within a wide range in respect of the morphology, depending on the physical properties of the substrate, the ceramic starting materials and the after-treatment processes. The process is employed for the production of catalysts, gas sensors and for deposition of thin metal films and further applications.

### DESCRIPTION OF THE INVENTION

It is an object of the present invention to provide a process of the type mentioned at the outset which can be carried out more simply and with lower capital costs and opens up a wide range of uses.

In terms of the process, the object is achieved according to the invention by admixing a solution or a suspension of an organic and/or inorganic metal compound with a mixed-in, insoluble pore former, spraying on the mixture as layer of a thin film and thermally decomposing and/or burning out the pore former to form an open-pored structure. Specific and further embodiments of the process are subject matter of dependent claims.

This process, known as spray pyrrolysis, is very simple and economical and can be carried out using extraordinarily inexpensive apparatuses. The ceramic-forming starting material is completely or partly dissolved in a suitable solvent to give a solution or suspension. The pore former is added in the form of particles or as suspension to this solution or suspension. A liquid pore former must neither be soluble in the solution nor mix homogeneously with the latter. In other words, an emulsion is formed by the addition of a liquid pore former.

The proportion by weight of the pore former can vary within a wide range, from 0.001 to 70% of the starting material for the ceramic. The efficiency of the process is increased when the pore former is distributed uniformly in the starting material, for example by means of a stirrer.

A wide range of metals is possible as metallic component of the starting material, in particular an alkali metal, alkaline earth metal, lanthanide, actinide, transition metal or semimetal. The individual metals can be taken from the Periodic Table of the Elements.

Both inorganic and organic components can be used for forming a metal compound. Inorganic components are, in particular, a halide, namely a fluoride, chloride or bromide, an oxide, hydroxide, nitrate, sulfate or perchlorate. Possible organic components are, in particular, an acetate, acetylacetonate, formate, carbonate or ethoxide. The starting material can consist of an individual inorganic or organic metal compound or else of any proportions of all three components.

To produce the solutions or suspensions, aqueous and/or customary organic solvents selected specifically according to the metal compounds used are employed. Account is also taken of occupational hygiene and environmental pollution aspects, which in other words means that water or unproblematical organic solvents are used whenever possible.

The pore former mixed into the solution or suspension of the starting materials has to be at least partially thermally decomposable or combustible. Inorganic materials which are suitable for this purpose are preferably finely divided carbon, especially in the form of amorphous carbon black or hexagonal graphite, and advantageous organic materials are polymers, preferably polymers having a molar mass of less than 6000 g/mol, in particular less than 1000 g/mol. These materials include, for example, polycarbonate and/or polystyrene. Like the inorganic materials, the polymers are finely divided, in particular submicron, since their size is critical in determining the future pore diameter in the thin film.

It is also possible to use liquid pore formers, for example ethylene glycol, but these must not be homogeneously miscible with the solvent. Droplets of the pore former which correspond approximately to the size of the finely divided pore former have to be formed during spraying.

The proportion by weight of the pore former in whatever form it is sprayed on is in the range from 0.001 to 70% of the starting material.

Further fine particles, in particular metal and/or alloy particles, can also be mixed into the mixture which is sprayed on if a thin film having good electrical conductivity is desired. The electrical conductivity can be additionally improved by impregnating the thin film or coating it with a metallic layer.

Spraying is continued until a layer thickness corresponding to from 0.5 to 20 times the pore diameter is reached. This corresponds in practice to a layer thickness of from 5 to 10000 nm.

Spraying of the mixture is preferably carried out by means of gas atomization, in particular by means of compressed air, electrostatic or ultrasonic atomization. The pressure employed in gas atomization is preferably at least about 0.5 bar; in particular, gas atomization is carried out using a pressure of from 1.5 to 3 bar. The droplet diameter of the sprayed-on dispersion is advantageously in a range from 1 to 150 μm, in particular from 2 to 6 μm. The particle size of the pore former is preferably in the submicron range.

As substrate, it is in principle possible to use any heat-resistant material having an appropriate mechanical strength. The substrate can be present in dense or porous form. The porosity can extend over the entire area or parts thereof. The substrate can also be flexible, for example in the form of a film, or rigid, for example in the form of a plate.

It is possible to spray on a single thin film having one layer, a thin film having a plurality of layers or a plurality of thin films, also with nonporous intermediate layers. The individual thin films or their layers are preferably dried before the next coating to at least such an extent that mixing and/or diffusion processes are minimized or prevented. Such mixing or diffusion processes can be disadvantageous in, for example, the application of anodic, cathodic and electrolyte layers.

In the case of strip-like, flexible substrates, the individual layers can also be sprayed on and decomposed and/or burned out stepwise in a continuous process. The strip runs through alternating spraying and thermal units.

The at least partial thermal decomposition or the burning-out of the pore formers is in practice usually carried out at a temperature of at least about 100° C., preferably in the range from 100 to 500° C., in particular in the range from 250 to 350° C. If desired, the substrate can be heated directly to the pyrrolysis temperature, i.e. to the temperature at which thermal decomposition or combustion of the pore former occurs, during the spraying process. Furthermore, the thin film after pyrrolysis can also be subjected to a further heat treatment at from 500° C. to 1200° C., preferably from 600° C. to 800° C., to crystallize the ceramic thin film which may possibly be at least partially amorphous at first.

The process of the invention gives, in particular, porous ceramic thin films having a thickness of from 1 to 10000 nm and a grain size in the range from 0.5 to 3000 nm. The pores have an average diameter which corresponds to the order of magnitude of the average grain size. The porosity varies in the range from 3 to 80% by volume, with at least part of the porosity being open.

The process of the invention can be employed in various ways, for example in the production of electrochemically active layers, electrodes, bonding layers, gas diffusion layers and mechanical protective layers. The use of the process in the production of miniaturized devices, in particular fuel cell and gas sensors, is of particular interest. The cathodes for solid oxide fuel cells (SOFCs) have to be porous to make reactions with a gas space possible. Of course, they also have to be electrically conductive. These cathodes composed of a ceramic thin film comprise, for example, La_{0.6}Sr_{0.4}Co_{0.2}Fe_{0.8}O₃.

Further advantageous embodiments and feature combinations of the invention can be derived from the following detailed description and the totality of the claims.

### BRIEF DESCRIPTION OF THE DRAWINGS

The invention is illustrated with the aid of the examples described in the drawing, which are also subject matter of dependent claims. The drawings schematically show:

FIG. 1 a process flow diagram of a spray pyrrolysis,

FIG. 2 a miniaturized sensor,

FIG. 3 an electrode configuration of a miniaturized solid oxide fuel cell,

FIG. 4 the overall electrical conductivity of a thin film with increasing proportion of pore former,

FIG. 5 a variant of FIG. 4 and

FIG. 6 the performance of a porous thin film cathode.

Identical parts in the figures are provided with identical reference numerals.

### WAYS OF PERFORMING THE INVENTION

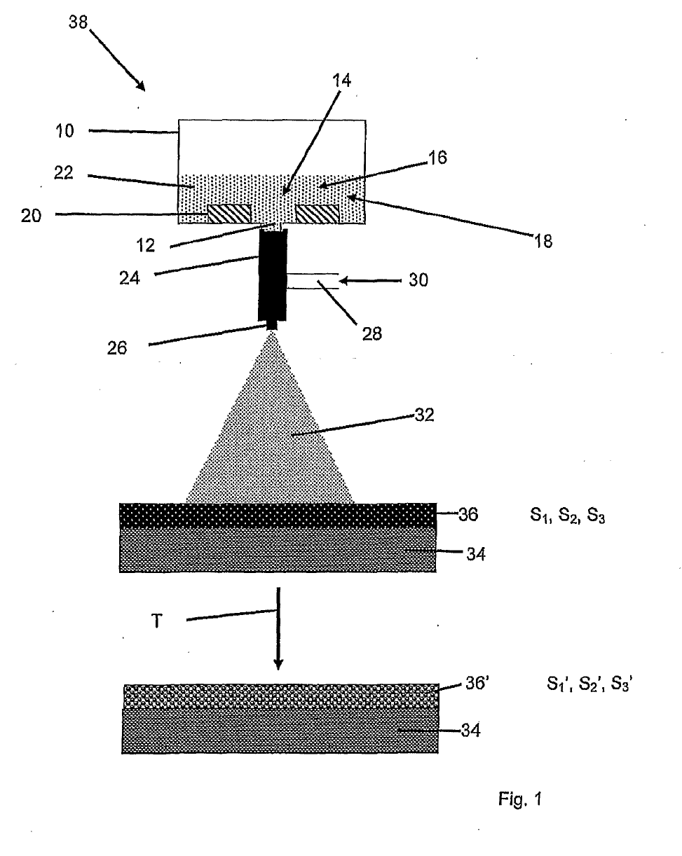

FIG. 1 shows a vessel 10 which has a closeable outlet 12 and into which organic and/or inorganic metal compounds as starting materials 14, a solvent 16 and a pore former 18 are introduced. Examples of these three components and their proportions in [mol/l] are given in Table 1 below. The vessel 10 is provided with mechanically or magnetically operable stirrers 20 which produce a mixture 22 of the starting materials 14 which are at least partly dissolved in the solvent 16 and the insoluble pore former 18. The addition of a solid pore former 18 results in a suspension, viz. the mixture 22, comprising a liquid phase composed of the solvent 16 or a solution of the starting material 14 which has been brought into the liquid phase and the above-mentioned finely dispersed solid phase. The addition of a liquid pore former 18 results in formation of an emulsion if the starting materials 14 are completely dissolved.

The outlet 12 of the vessel 10 conducts the mixture 22 into a spray apparatus 24 having an atomizer nozzle 26. The spray apparatus 24 comprises a lateral gas inlet 28, in general for compressed air 30, which produces a spray cone 32 of the mixture 22.

The spray cone 32 impinges on a fixed or moving substrate 34 and forms a thin film 36 or a layer S₁, S₂ or S₃ thereof. The thickness of the applied layer depends on a number of parameters, for example the duration of spraying, the amount sprayed on per unit time and area, the velocity of a moving substrate.

The arrow T indicates a heat treatment at a temperature T of, in the present case, about 300° C., by means of which the pore former 18 is decomposed or burned out. This produces a porous, ceramic thin film 36′ comprising at least one porous, ceramic layer S′₁, S′₂, S′₃.

FIG. 1 shows the production of a porous thin film 36′ by spray pyrrolysis in a stationary process. In an abovementioned variant of FIG. 1 which is not shown, a moving substrate is provided and a number of spray pyrrolysis apparatuses 38 corresponding to the number of porous, ceramic thin films 36′ having the layers S′₁, S′₂, S′₃, . . . and, alternating therewith, heat treatment facilities for the decomposition or burning-out of the pore formers at a temperature indicated in Table 1 [° C.] are provided.

An apparatus for spray pyrrolysis leaves open numerous variants. Thus, the starting material 14 and the solvent 16 can firstly be introduced into the vessel 10 and the pore former 18 can be added only after intensive stirring. The atomizer nozzle 26 can be interchangeable so that the geometric configuration of the spray cone 32 and the flow can be varied. The distance of the atomizer nozzle 26 from the substrate 34 is advantageously also adjustable.

The variation of the starting material 14, the solvent 16, the pore former 18 and the pyrrolysis temperature T is indicated in Table 1 below.

TABLE 1

| Starting | | | Pyrrolysis |
|---|---|---|---|
| material | Pore former | Solvent | temperature |
| [mol/l] | [g/l] | [volume ratio] | T [° C.] |
| 0.016 | 3 graphite | ⅓ ethanol, | 300 |
| Ce(NO₃)₃•6H₂O, | | ⅓ 1-methoxy- | |
| 0.004 | | 2-propanol, | |
| Gd(NO₃)₃•6H₂O | | ⅓ diethylene | |
| | | glycol | |
| | | monobutyl ether | |
| 0.006 | 0.006 carbon | ⅓ ethanol, | 270 |
| La(NO₃)₃•6H₂O, | black | ⅔ diethylene | |
| 0.004 | | glycol | |
| SrCl₂•6H₂O, | | monobutyl ether | |
| 0.002 | | | |
| Co(NO₃)₂•6H₂O | | | |
| 0.008 | | | |
| Fe(NO₃)₃•9H₂O | | | |
| 0.005 Ba(NO₃)₂, | 0.5 carbon | ⅓ ethanol, | 155 |
| 0.005 Sr(NO₃)₂, | black | ⅔ water | |
| 0.008 | | | |
| Co(NO₃)₂•6H₂O | | | |
| 0.002 | | | |
| Fe(NO₃)₃•9H₂O | | | |

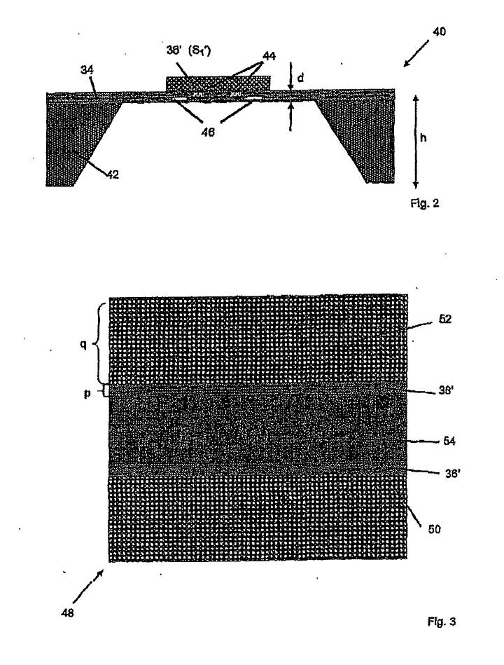

FIG. 2 shows a miniaturized sensor 40 on a microhotplate 42. A mechanically stable substrate 34 composed of silicon nitride which together with a porous ceramic thin film 36′ comprising a layer S₁′, forms a membrane is installed on this support foundation. In the region of the thin film 36′, in the present case composed of tin oxide, metallic electrodes 44 which transmit the detected signals for evaluation are provided. Furthermore, two heating elements 46, in the present case composed of platinum, are arranged in the substrate 34 in the region of the porous ceramic thin film 36′. The thickness d of the substrate 34 is exaggerated in the drawing and is about 1 μm, while the height h of the miniaturized sensor 40 is about 400 μm and its width is about 1000 μm.

FIG. 3 shows a laminated electrode configuration 48 of a solid oxide fuel cell (SOFC) known per se in the form of a partial cross section. The laminate structure comprises a porous thick film anode 50, a porous thick film cathode 52 and a thick film electrolyte 54 located between them. All three layers are likewise known per se and are used in solid oxide fuel cells. According to FIG. 3, a porous ceramic thin film 36′ according to the present invention is located between the porous thick film anode 50 and the thick film electrolyte 54 and between the porous thick film cathode 52 and the thick film electrolyte 54. The fine structure of the porous ceramic thin films 36′ produces significantly better contact with the gastight thick film electrolyte layer 54 than could be achieved by the thick coarse-grained standard electrodes alone. The fine porous structure at the same time ensures that gas access is not blocked. An improvement in performance likewise takes place as a result. The thickness ratio of the inventive layers 36′ to the known thick film layers 50, 52, 54 is about 1:100. In the present case, the layer thickness p of the thin films 36′ is 300 nm, while the layer thickness q of the thick film electrodes is about 30 μm.

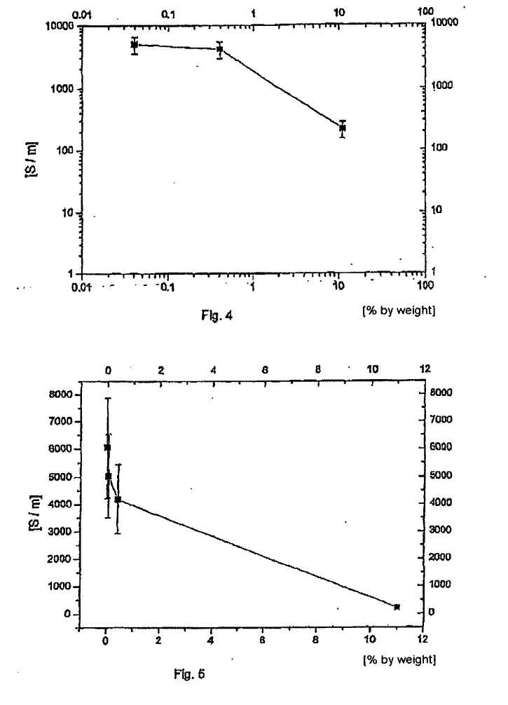

FIGS. 4 and 5 show the relationship between the electrical conductivity [S/m] as a function of the amount [% by weight] for a cathodic porous ceramic thin film 36′. The values plotted relate to the overall conductivity of an La_{0.6}Sr_{0.4}Co_{0.2}Fe_{0.8}O₃ thin film. In addition, the performance of the cathode is improved considerably by the increased proportion of pore formers 18 or the increased porosity.

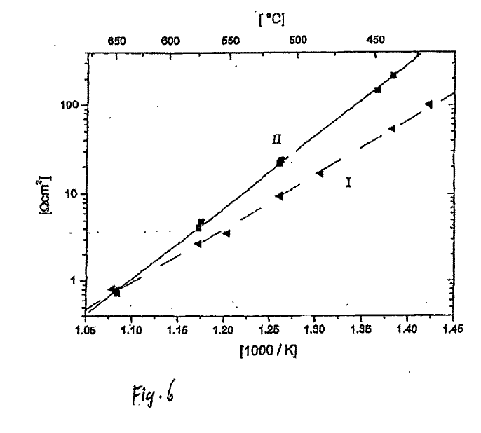

This can be seen from FIG. 6 where the polarization resistance [Ωcm²] is plotted against the temperature [° C.] or against the reciprocal absolute temperature [1000/° K]. The curve I, which is based on a ceramic thin film cathode 36′ containing pore formers 18 (FIG. 1), shows a lower polarization resistance [Ωcm²] and thus a better performance than that of a thin film cathode 36′ without film formers as shown by curve II.

1. A process for coating a sheet-like substrate (34) with at least one thin film (36′) comprising at least one porous ceramic layer (S′ 1, S′2, S′3, . . . ), characterized in that a solution or a suspension of an organic and/or inorganic metal compound as starting material (14) is admixed with a mixed-in, insoluble pore former (18), the mixture (22) is sprayed on as layer (S₁, S₂, S₃, . . . ) of a thin film (36) and the pore former (18) is at least partially thermally decomposed and/or burned out to form an at least partially open-pored structure.

2. The process as claimed in claim 1, characterized in that the spraying of the mixture (22) is effected by means of gas atomization, preferably by means of compressed air (30), electrostatic or ultrasonic atomization.

3. The process as claimed in claim 2, characterized in that the gas atomization of the mixture (22) is carried out at a pressure of at least about 0.5 bar, preferably from 1.5 to 3 bar.

4. The process as claimed in claim 1, characterized in that the mixture (22) is sprayed on with a droplet diameter of from 1 to 150 μm, preferably from 2 to 6 μm.

5. The process as claimed in claim 1, characterized in that the mixture (22) is sprayed with a starting material (14) comprising at least one metallic component comprising an alkali metal, alkaline earth metal, lanthanide, actinide, transition metal or semimetal and an inorganic component comprising a halide, oxide, hydroxide, nitrate, sulfate or perchlorate and/or an organic component comprising an acetate, acetylacetonate, formate, oxalate, carbonate or ethoxide.

6. The process as claimed in claim 1, characterized in that the mixture (22) is sprayed with the pore former (18) comprising at least one thermally decomposable or combustible substance which comprises finely divided carbon, in particular carbon black or graphite, or an organic material, preferably a polymer, having a molar mass of <6000 g/mol, in particular <1000 g/mol.

7. The process as claimed in claim 6, characterized in that the substrate (34) is heated directly to the pyrrolysis temperature (T) during spraying on.

8. The process as claimed in claim 1, characterized in that the mixture (22) is sprayed on with a proportion by weight of the pore former of from 0.001 to 70% of the starting material (14) and a particle size of not more than 10000 nm, preferably not more than 200 nm, until a layer thickness corresponding to from 0.5 to 50 times the pore diameter is reached.

9. The process as claimed in claim 1, characterized in that a mixture (22) doped with metal and/or alloy particles is sprayed on.

10. The process as claimed in claim 1, characterized in that the pore former (18) is decomposed and/or burned out at a temperature of at least 100° C., preferably from 100 to 500° C., in particular from 250 to 350° C.

11. The process as claimed in claim 1, characterized in that the thin film (36′) is subjected to a further heat treatment, preferably at from 500° C. to 1200° C., in particular from 600° C. to 800° C., after pyrrolysis.

12. The use of the process as claimed in claim 1 for producing miniaturized devices, in particular fuel cells and gas sensors (40), electrochemically active layers, electrodes, bonding layers, gas diffusion layers and mechanical protective layers.

13. The process as claimed in claim 2, characterized in that the mixture (22) is sprayed on with a droplet diameter of from 1 to 150 μm, preferably from 2 to 6 μm.

14. The process as claimed in claim 3, characterized in that the mixture (22) is sprayed on with a droplet diameter of from 1 to 150 μm, preferably from 2 to 6 μm.

15. The process as claimed in claim 2, characterized in that the mixture (22) is sprayed with a starting material (14) comprising at least one metallic component comprising an alkali metal, alkaline earth metal, lanthanide, actinide, transition metal or semimetal and an inorganic component comprising a halide, oxide, hydroxide, nitrate, sulfate or perchlorate and/or an organic component comprising an acetate, acetylacetonate, formate, oxalate, carbonate or ethoxide.

16. The process as claimed in claim 3, characterized in that the mixture (22) is sprayed with a starting material (14) comprising at least one metallic component comprising an alkali metal, alkaline earth metal, lanthanide, actinide, transition metal or semimetal and an inorganic component comprising a halide, oxide, hydroxide, nitrate, sulfate or perchlorate and/or an organic component comprising an acetate, acetylacetonate, formate, oxalate, carbonate or ethoxide.

17. The process as claimed in claim 4, characterized in that the mixture (22) is sprayed with a starting material (14) comprising at least one metallic component comprising an alkali metal, alkaline earth metal, lanthanide, actinide, transition metal or semimetal and an inorganic component comprising a halide, oxide, hydroxide, nitrate, sulfate or perchlorate and/or an organic component comprising an acetate, acetylacetonate, formate, oxalate, carbonate or ethoxide.

18. The process as claimed in claim 2, characterized in that the mixture (22) is sprayed with the pore former (18) comprising at least one thermally decomposable or combustible substance which comprises finely divided carbon, in particular carbon black or graphite, or an organic material, preferably a polymer, having a molar mass of <6000 g/mol, in particular <1000 g/mol.

19. The process as claimed in claim 3, characterized in that the mixture (22) is sprayed with the pore former (18) comprising at least one thermally decomposable or combustible substance which comprises finely divided carbon, in particular carbon black or graphite, or an organic material, preferably a polymer, having a molar mass of <6000 g/mol, in particular <1000 g/mol.

20. The process as claimed in claim 4, characterized in that the mixture (22) is sprayed with the pore former (18) comprising at least one thermally decomposable or combustible substance which comprises finely divided carbon, in particular carbon black or graphite, or an organic material, preferably a polymer, having a molar mass of <6000 g/mol, in particular <1000 g/mol.
